(19) United States
(12) Patent Application Publication
(10) Pub. No.: US 2026/0370019 A1
(43) Pub. Date: Nov. 19, 2026

(54) BATTERY SYSTEM WITH A RELAY

(71) Applicant: Caterpillar Inc., Peoria, IL (US)

(72) Inventors: Matthew Peter Jacoutot, London (GB); Robert David Busby, Whittlesey (GB); Saif Sayed, Milton Keynes (GB)

(73) Assignee: Caterpillar Inc., Peoria, IL (US)

(21) Appl. No.: 19/208,417

(22) Filed: May 14, 2025

(51) Int. Cl. H02J 7/60; H02H 7/18; H02J 7/50; H02J 7/80

(52) U.S. Cl. CPC H02J 7/663; H02H 7/18; H02J 7/50; H02J 7/80

(57) ABSTRACT

A battery system may include a battery cell, a contactor configured to selectively isolate the battery cell from a load, a first sensor and a second sensor configured to measure an electrical property across the contactor, and a relay. The first sensor may be connected in a first signal path connected at an upstream side of the contactor. The second sensor may be connected in a second signal path connected at a downstream side of the contactor. The first sensor and the second sensor may share a reference point that provides a pathway across the contactor. The relay, in the first signal path or the second signal path, may be configured to be open when the contactor is open.

### TECHNICAL FIELD

The present disclosure relates generally to batteries and, for example, to a battery system with a relay.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells.

In such battery packs, contactors serve as switching devices that control the connection between the battery voltage and the output connectors. When the contactors are open, they may create a barrier that prevents voltage from reaching the output. Voltage sensors may be used to measure the potential difference across the contactors to monitor pre-charge processes and detect issues such as contactor welds. However, voltage sensing configurations may introduce unintended pathways for current flow. Specifically, common ground voltage sensors may provide a high-resistance pathway across the contactors, allowing the Y-capacitance of a machine or application (to which the battery pack is connected) to charge. As a result, voltage levels may appear between the output terminals and ground, leading to unexpected voltage readings when measured with a multimeter. In battery systems with high Y-capacitance values, this may create the false impression that voltage is present at the output terminals when it is not expected.

Korea Patent No. 102,258,736 (the '736 patent) discloses a battery system overvoltage protection device. The device detects overcharge by electrical change in an apparatus for preventing overvoltage of a battery system and supplies to the battery during overcharge by using a passive element. The '736 patent does not address preventing unintended voltage pathways across a contactor.

The battery system of the present disclosure solves one or more of the problems set forth above and/or other problems in the art.

### SUMMARY

A battery pack may include a plurality of battery cells, a first contactor and a second contactor configured to selectively isolate the plurality of battery cells from output connectors of the battery pack, a first sensor and a second sensor configured to measure an electrical property across at least one of the first contactor or the second contactor, and a relay. The first contactor may be in a first electrical path from a first terminal of the plurality of battery cells. The second contactor may be in a second electrical path from a second terminal of the plurality of battery cells. The first sensor may be in a first signal path connected between the first electrical path and the second electrical path. The second sensor may be in a second signal path connected between the first electrical path and the second electrical path. The first sensor and the second sensor may share a reference point in the first electrical path or the second electrical path. The relay, in the first signal path or the second signal path, may be configured to be open when at least one of the first contactor or the second contactor is open.

A battery system may include a battery cell, a contactor configured to selectively isolate the battery cell from a load, a first sensor and a second sensor configured to measure an electrical property across the contactor, and a relay. The first sensor may be connected in a first signal path connected at an upstream side of the contactor. The second sensor may be connected in a second signal path connected at a downstream side of the contactor. The first sensor and the second sensor may share a reference point that provides a pathway across the contactor. The relay, in the first signal path or the second signal path, may be configured to be open when the contactor is open.

A method may include causing, by a controller, opening of a relay concurrently with opening a contactor configured to selectively isolate a battery cell from a load. The relay may be in a first signal path that includes a first sensor and may be connected at an upstream side of the contactor, or in a second signal path that includes a second sensor and is connected at a downstream side of the contactor. The first sensor and the second sensor may share a reference point that provides a pathway across the contactor. Opening the relay may block current flow through the first signal path or the second signal path. The method may include causing, by the controller, closing of the relay concurrently with closing the contactor.

### BRIEF DESCRIPTION OF THE DRAWINGS

FIG. 1 is a diagram of an example battery pack.

FIG. 2 is a diagram of an example battery system.

FIG. 3 is a diagram of an example battery system.

FIG. 4 is a diagram of an example battery system.

FIG. 5 is a flowchart of an example method.

### DETAILED DESCRIPTION

This disclosure relates to a battery system, which is applicable to any battery-electric machine (or any battery-electric application). For example, the machine may be a paving machine, a compactor machine, a cold planer, a grading machine, a backhoe loader, a wheel loader, a harvester, an excavator, a motor grader, a skid steer loader, a tractor, a dozer, a vehicle, or the like.

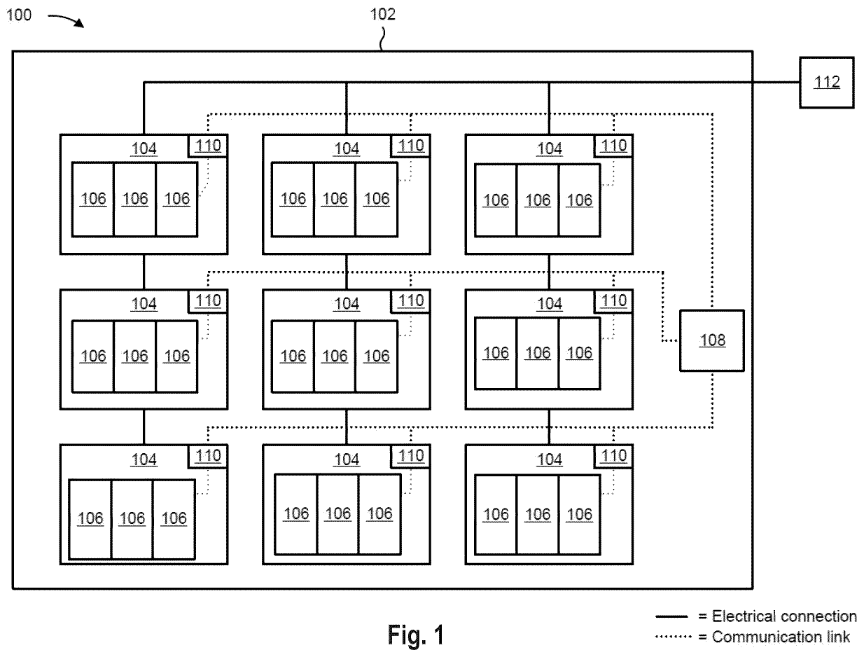

FIG. 1 is a diagram of an example battery pack 100. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. In some examples, although shown as being included within the battery pack housing 102, the battery pack controller 108 may be positioned outside the battery pack housing 102. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as electronics or an electric motor, among other examples. As another example, the component 112 provides energy to the battery pack 100 (e.g., to be stored by the battery cells 106). In such examples, the component 112 may be a power generator, a solar energy system, and/or a wind energy system, among other examples.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion) (e.g., lithium ion polymer (Li-ion polymer), lithium iron phosphate (LFP), and/or nickel manganese cobalt (NMC)), nickel-metal hydride (NiMH), or nickel cadmium (NiCd), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles, among other examples.

The battery pack controller 108 and/or a module controller 110 includes one or more processors and/or one or more memories. A processor may include a central processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. A memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the battery pack 100, a battery module 104, and/or a battery cell 106. The memory may include one or more memories that are coupled (e.g., communicatively coupled) to the processor, such as via a bus. Communicative coupling between a processor and a memory may enable the processor to read and/or process information stored in the memory and/or to store information in the memory.

As described herein, the battery pack 100 includes a circuit and/or a circuit component such as a relay configured to be open when a contactor of the battery pack 100 is open, thereby preventing unintended voltage pathways.

As indicated above, FIG. 1 is provided as an example. Other examples may differ from what is described with regard to FIG. 1.

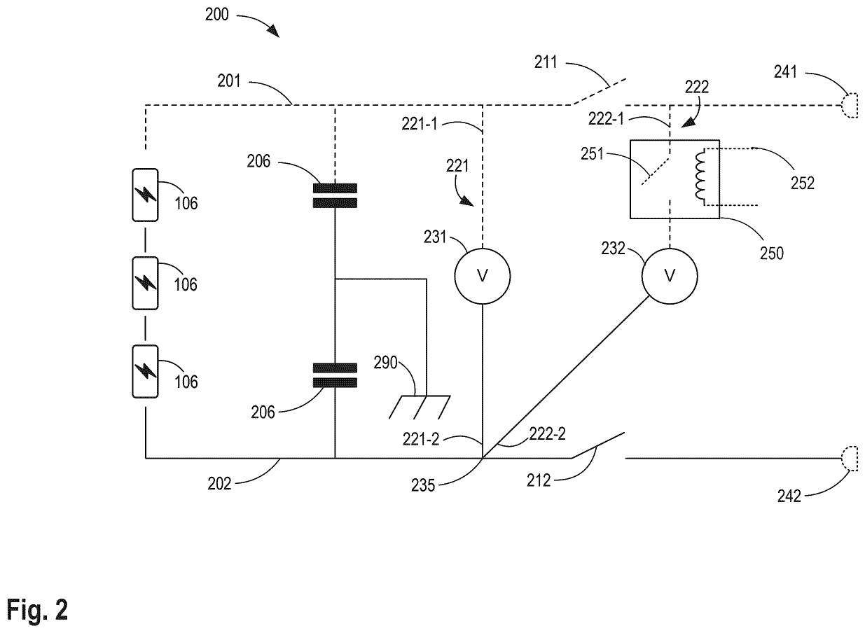

FIG. 2 is a diagram of an example battery system 200. The battery system 200 may be part of and/or operatively coupled with the battery pack 100. For example, the battery system 200 may be a circuit included in the battery pack 100. The battery system 200 includes the battery cells 106, a first electrical path 201, a second electrical path 202, a first contactor 211, a second contactor 212, a first signal path 221, a second signal path 222, a first sensor 231, a second sensor 232, a first output connector 241, a second output connector 242, and a relay 250. The battery cells 106 may have a Y-capacitance, which is represented by capacitors 206 shown in FIG. 2.

The first electrical path 201 may be connected to a first terminal of the battery cells 106. The second electrical path 202 may be connected to a second terminal of the battery cells 106. For example, the first electrical path 201 may be connected to a positive terminal (or a negative terminal) of the battery cells 106, while the second electrical path 202 is connected to the negative terminal (or the positive terminal) of the battery cells 106. The first electrical path 201 may include or be electrically connected to the first contactor 211 and the first output connector 241. The second electrical path 202 may include or be electrically connected to the second contactor 212 and the second output connector 242.

The first contactor 211 and the second contactor 212 may selectively isolate the battery cells 106 from the first output connector 241 and the second output connector 242, respectively. In some examples, in which the first output connector 241 and the second output connector 242 are connected to a load, the first contactor 211 and the second contactor 212 can selectively isolate the battery cells 106 from the load. Each of the first contactor 211 and the second contactor 212 may include a switch and a coil. In some examples, the first contactor 211 (or the second contactor 212) may be a normally open contactor. The switch of the first contactor 211 (or the second contactor 212) can remain open when no current flows through the coil of the first contactor 211 (or the second contactor 212). With an electrical current applied to the coil of the first contactor 211 (or the second contactor 212), the coil can generate a magnetic field that closes the switch of the first contactor 211 (or the second contactor 212). In some other examples, the first contactor 211 (or the second contactor 212) may be a normally closed contactor. In these examples, the switch of the first contactor 211 (or the second contactor 212) can remain closed when no current flows through the coil of the first contactor 211 (or the second contactor 212). With an electrical current applied to the coil, the coil can generate a magnetic field that opens the switch of the first contactor 211 (or the second contactor 212).

The first signal path 221 may be connected between the first electrical path 201 and the second electrical path 202. The second signal path 222 may also be connected between the first electrical path 201 and the second electrical path 202. For example, as shown in FIG. 2, first ends 221-1, 222-1 of the first signal path 221 and the second signal path 222 are electrically connected to the first electrical path 201. The first end 221-1 may be a first connection point of the first signal path 221 at one side of the first signal path 221, and the first end 222-1 may be a first connection point of the second signal path 222 at one side of the second signal path 222. Second ends 221-2, 222-2 of the first signal path 221 and the second signal path 222 are electrically connected to the second electrical path 202. The second end 221-2 may be a second connection point of the first signal path 221 at another (e.g., opposite to the first end 221-1) side of the first signal path 221, and the second end 222-2 may be a second connection point of the second signal path 222 at another (e.g., opposite to the first end 222-1) side of the second signal path 222. In some implementations, the first ends 221-1, 222-1 of the first signal path 221 and the second signal path 222 may be electrically connected to the first electrical path 201 at different portions thereof. As shown in FIG. 2, the first end 221-1 of the first signal path 221 may be connected at an upstream side of the first contactor 211, while the first end 222-1 of the second signal path 222 may be connected at a downstream side of the first contactor 211 (e.g., the first end 221-1 of the first signal path 221 and the first end 222-1 of the second signal path 222 may be connected at opposite sides of the first contactor 211). The second ends 221-2, 222-2 of the first signal path 221 and the second signal path 222 may be connected to the second electrical path 202 at a shared reference point 235 (e.g., a common ground point). The shared reference point 235 may be located at an upstream side of the second contactor 212. The shared reference point 235 may provide a pathway across the first contactor 211.

Although not shown, in other examples, the first ends 221-1, 222-1 of the first signal path 221 and the second signal path 222 may be electrically connected to the second electrical path 202 at different portions thereof. For example, the second end 221-2 of the first signal path 221 may be connected at an upstream side of the second contactor 212, while the second end 222-2 of the second signal path 222 may be connected at a downstream side of the second contactor 212. In these examples, the first ends 221-1, 222-1 of the first signal path 221 and the second signal path 222 may be connected to the first electrical path 201 at a shared reference point (not shown).

Each of the first signal path 221 and the second signal path 222 may be a bus voltage measurement line. The first signal path 221 may include and/or be operatively connected to the first sensor 231. For example, the first sensor 231 may be connected between the first electrical path 201 and the second electrical path 202, on the first signal path 221. The second signal path 222 may include and/or be operatively connected to the second sensor 232. For example, the second sensor 232 may be connected between the first electrical path 201 and the second electrical path 202, on the second signal path 222. Each of the first sensor 231 and the second sensor 232 may be a voltmeter, a multimeter, or another type of voltage sensor configured to measure a voltage on the respective bus voltage measurement line.

The first sensor 231 and the second sensor 232 may be configured to measure an electrical property across at least one of the first contactor 211 or the second contactor 212. The first sensor 231 and the second sensor 232 may be connected to, and share, the reference point 235 in the second electrical path 202. For example, in this configuration, the first sensor 231 and the second sensor 232 can measure a voltage across the first contactor 211. In other examples, in which the second end 221-2 of the first signal path 221 is connected at the upstream side of the second contactor 212, and the second end 222-2 of the second signal path 222 is connected at the downstream side of the second contactor 212, the first sensor 231 and the second sensor 232 can measure a voltage across the second contactor 212. In these examples, the first sensor 231 and the second sensor 232 may share a reference point in the first electrical path 201.

The battery system 200 includes the relay 250. The relay 250 may include a relay switch 251 and a relay coil 252. The relay 250 may be located in the bus volage measurement line (e.g., in the first signal path 221 or in the second signal path 222). As shown, the relay 250 may be located in the second signal path 222, between the first end 222-1 of the second signal path 222 and the second sensor 232. Although not shown, the relay 250 may be located between the second sensor 232 and the second end 222-2 of the second signal path 222, between the first sensor 231 and the second end 221-2 of the first signal path 221, or between the first sensor 231 and the first end 221-1 of the first signal path 221.

The relay 250 can be electrically controlled to control current flow on the bus volage measurement line. For example, as shown in FIG. 2, the relay 250 can control current flow on the second signal path 222. In some examples, the relay 250 may be a normally open relay. Here, the switch 251 can remain open when no current flows through the relay coil 252. With an electrical current applied to the relay coil 252, the relay coil 252 can generate a magnetic field that closes the relay switch 251. As discussed herein, the relay 250 may be configured to be open when at least one of the first contactor 211 or the second contactor 212 is open. In some other examples, the relay 250 may be a normally closed relay. In these examples, the switch 251 can remain closed when no current flows through the relay coil 252. With an electrical current applied to the relay coil 252, the relay coil 252 can generate a magnetic field that opens the relay switch 251. The relay 250 may be configured to be open when at least one of the first contactor 211 or the second contactor 212 is open.

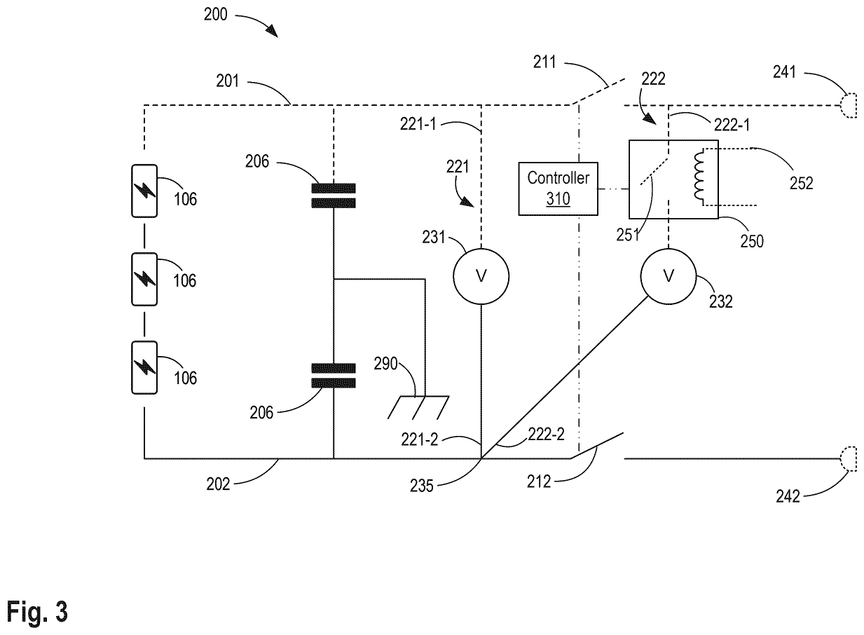

FIG. 3 is a diagram of another example of the battery system 200. In the example of FIG. 3, the battery system 200 additionally includes a controller 310.

As described herein, the battery system 200 may be controlled by the controller 310. The controller 310 includes one or more processors and/or one or more memories. A processor may include a central processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. A memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the relay 250, the relay switch 251, the relay coil 252, the first contactor 211, the second contactor 212, etc. The memory may include one or more memories that are coupled (e.g., communicatively coupled) to the processor, such as via a bus. Communicative coupling between a processor and a memory may enable the processor to read and/or process information stored in the memory and/or to store information in the memory. In some implementations, the controller 310 may be part of or communicatively coupled with the battery pack controller 108 and/or the module controller 110.

The controller 310 may control the relay 250 concurrently with controlling the first contactor 211 and/or the second contactor 212 (e.g., causing opening of the relay 250 concurrently with opening the first contactor 211, or causing closing of the relay 250 concurrently with closing the first contactor 211). The controller 310 may control the relay 250, the first contactor 211, and/or the second contactor 212 by transmitting electrical signals to the relay 250, the first contactor 211, and/or the second contactor 212. In some examples, the controller 310 may control the relay 250 concurrently with controlling the first contactor 211 that serves as a negative contactor (or a positive contactor). In these examples, the controller 310 may control the relay 250 to be open, concurrently controlling the first contactor 211 to be open. The relay 250 in the open position can block current flow through the first signal path 221, while current flow across the first contactor 211 is blocked. By preventing current flow from flowing through the first signal path 221 and current flow from flowing through the first contactor 211, the relay 250 in the open position can block charging of the Y-capacitance of a machine or application (to which the battery cells 106 are connected), which may otherwise lead to unexpected voltage readings between the first output connector 241 and a ground point 290 (and/or between the second output connector 242 and the ground point 290).

The controller 310 may control the relay 250 to be closed, concurrently controlling the first contactor 211 to be closed. In some implementations, the controller 310 may control the second contactor 212 to be closed, concurrently controlling the first contactor 211 to be closed. Accordingly, when the relay 250 is in the closed position, the first contactor 211 and/or the second contactor 212 can be closed.

The relay 250 and the first contactor 211 (and/or the second contactor 212) can be operatively coupled in various manners to perform the concurrent operations. In some examples, the controller 310 may be a contactor driver of the first contactor 211 or the second contactor 212. For example, the first contactor 211 may be a negative contactor (or a positive contactor), and the controller 310 may be a negative contactor driver of the first contactor 211. In these examples, the negative contactor driver of the first contactor 211 may concurrently control operations of the relay 250 and the first contactor 211 (e.g., causing opening of the relay 250 concurrently with opening the first contactor 211, or causing closing of the relay 250 concurrently with closing the first contactor 211). In some other examples, the relay 250 and the first contactor 211 are on a same driver. That is, the relay 250 and the first contactor 211 can share the same driver configured to concurrently control the relay 250 and the first contactor 211. In some implementations, the first contactor 211 may be a negative contactor (or a positive contactor), and the relay coil 252 may be connected in series with a negative contactor driver coil of a contactor driver configured to drive the first contactor 211. The shared driver, and/or the serial connection between the relay coil 252 and the negative contactor driver coil for the first contactor 211, allow the relay coil 252 to be controlled concurrently with the first contactor 211.

In some examples, the relay 250 may be controlled independently (e.g., independent of the first contactor 211 (and/or the second contactor 212)). For example, the relay 250 may be controlled based on a state of a high-voltage interlock (HVIL) circuit (e.g., as discussed below), a power state of a machine or application, or a signal from another control system (e.g., a controller or a control system lacking a control connection to the first contactor 211 and the second contactor 212). In these examples, the relay 250 may remain open based on whether the system determines that voltage sensing is appropriate.

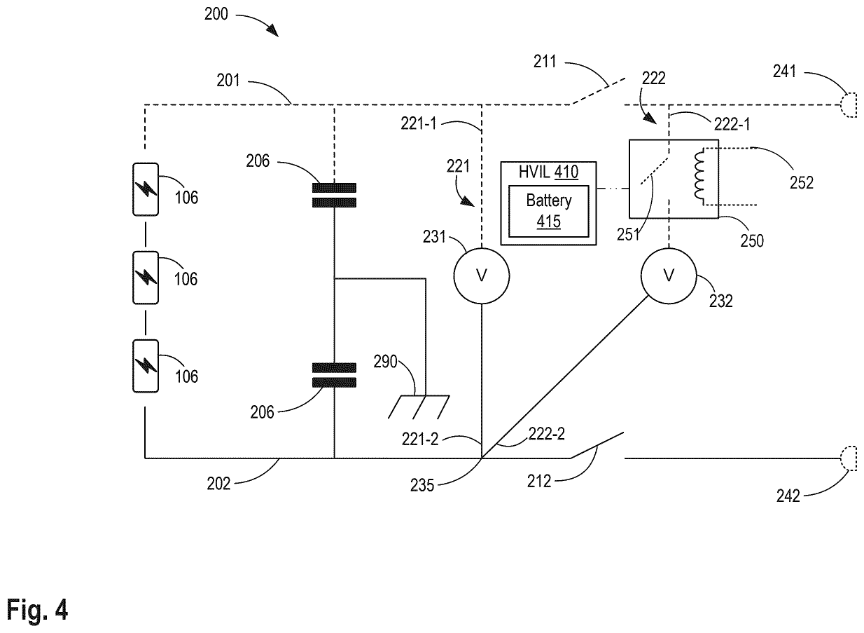

FIG. 4 is a diagram of another example of the battery system 200. In the example of FIG. 4, the battery system 200 additionally includes a high voltage interlock (HVIL) circuit 410.

In some examples, the HVIL circuit 410 may be a circuit that is part of or communicatively coupled with the battery pack controller 108, the module controller 110, and/or the controller 310. In some other examples, the HVIL circuit 410 may be a separate circuit operatively coupled with components (e.g., the relay 250, the first contactor 211, the second contactor 212, etc.) of the battery system 200. The HVIL circuit 410 may include a separate battery 415 from the battery cells 106 to power the HVIL circuit 410.

The HVIL circuit 410 can drive the relay 250 based on the status of high-voltage connections within the battery system 200. For example, HVIL circuit 410 may be arranged to detect whether the battery cells 106, the first contactor 211, the second contactor 212, the first output connector 241, the second output connector 242, etc. are securely connected before allowing the relay 250 to open or close. For example, when any of the system components (e.g., the battery cells 106, the first contactor 211, the second contactor 212, the first output connector 241, the second output connector 242, etc.) is improperly seated or disconnected, the HVIL circuit 410 may keep the relay 250 in the open position, thereby preventing unintended current flow and reducing the risk of voltage exposure. The HVIL circuit 410 can thereby ensure that voltage sensing and contactor monitoring are active when the battery system 200 is in a safe and operational state.

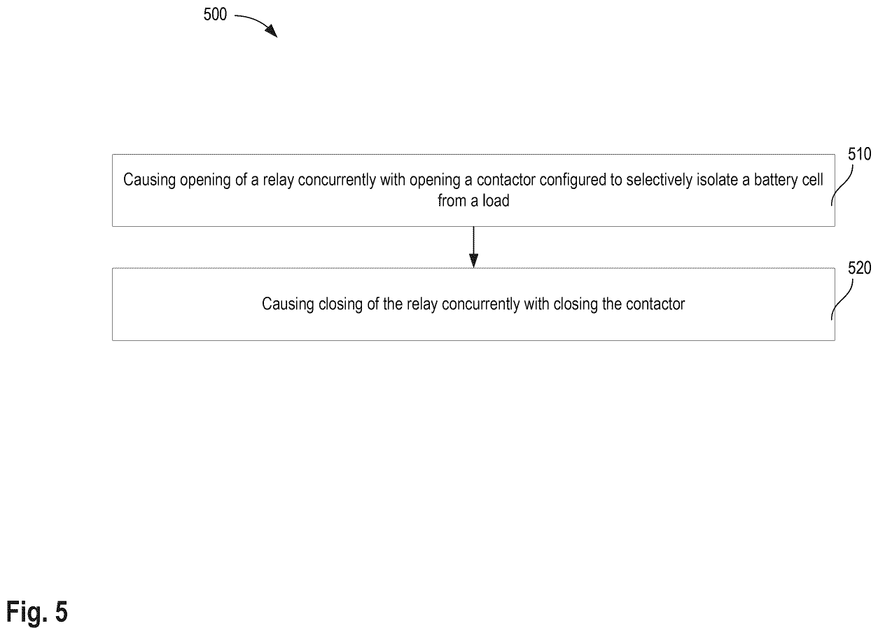

FIG. 5 is a flowchart of an example method 500. One or more steps of the method 500 may be performed by one or more controllers (e.g., the controller 310). Additionally, or alternatively, one or more steps of the method 500 may be performed by another device or a group of devices separate from or including the controller(s), such as another device or component that is internal or external to the battery pack 100.

At step 510, the method 500 may include causing (e.g., by the controller 310) opening of a relay (e.g., the relay 250) concurrently with opening a contactor (e.g., one of the first contactor 211 and the second contactor 212) configured to selectively isolate a battery cell (e.g., the battery cell 106) from a load. The relay may be in a first signal path (e.g., the first signal path 221) that includes a first sensor (e.g., the first sensor 231) and is connected at an upstream side of the contactor. The relay may be in a second signal path (e.g., the second signal path 222) that includes a second sensor (e.g., the second sensor 232) and is connected at a downstream side of the contactor. The first sensor and the second sensor may share a reference point (e.g., the reference point 235) that provides a pathway across the contactor. In some examples, opening the relay may block current flow through the first signal path and the second signal path.

At step 520, the method 500 may include causing (e.g., by the controller 310) closing of the relay concurrently with closing the contactor. In some examples, the contactor is a first contactor, and the method 500 may include causing (e.g., by the controller 310) closing of a second contactor (e.g., the other one of the first contactor 211 and the second contactor 212) configured to selectively isolate the battery cell from the load, concurrently with closing the first contactor. The method 500 may include controlling (e.g., by the controller 310) the contactor to prevent the Y-capacitance (of the machine or application) from being charged while the relay is open. This can prevent unexpected voltage readings between a connector (e.g., the first output connector 241 and/or the second output connector 242) and a ground point (e.g., the ground point 290).

Although FIG. 5 shows example steps of the method 500, in some implementations, the method 500 may include additional steps, fewer steps, different steps, or differently arranged steps than those depicted in FIG. 5. Additionally, or alternatively, two or more of the steps of the method 500 may be performed in parallel.

### INDUSTRIAL APPLICABILITY

The battery system 200 described herein may be used with any electrical machinery that operates based on batteries (e.g., the battery pack 100) or any hybrid variations that include a battery pack as an energy source. In particular, the battery system 200 may be used in a battery-electric machine (or application) that operates at a worksite or other setting to improve voltage readings (e.g., preventing unexpected voltage readings between the first output connector 241 and the ground point 290 and/or between the second output connector 242 and the ground point 290). For example, the battery system 200 may be used in a haul truck, a vehicle, a compactor machine, a paving machine, a cold planer, a grading machine, a backhoe loader, a wheel loader, a harvester, an excavator, a motor grader, a skid steer loader, a tractor, a dozer, or another type of work machine that performs road surfacing operations, earth moving operations, or the like. In conventional battery packs, voltage sensors may introduce high-resistance pathways across open contactors, leading to unintended charging of the Y-capacitance of a machine or application and voltage readings at output terminals, complicating maintenance and resulting in machine downtime to conduct unnecessary maintenance or troubleshooting.

In order to address these issues, the battery system 200 described herein includes the relay 250. The relay 250 can be controlled based on the position of the first contactor 211 and/or the second contactor 212, ensuring that the voltage sensing pathway is broken when the first contactor 211 and/or the second contactor 212 are open. By preventing the Y-capacitance measurement (e.g., at each of the first output connector 241 and the second output connector 242) under these conditions, the battery system 200 reduces the risk of unexpected voltage at the output terminals (e.g., the first output connector 241 and the second output connector 242), at which a multimeter would otherwise read a residual voltage even when the contactors are open, thereby simplifying maintenance and reducing machine downtime. Furthermore, integrating the relay 250 with the HVIL circuit 410 allows for reliable contactor weld detection without requiring additional drivers.

What is claimed is:

1. A battery pack, comprising:
a plurality of battery cells;
a first contactor and a second contactor configured to selectively isolate the plurality of battery cells from output connectors of the battery pack,
the first contactor in a first electrical path from a first terminal of the plurality of battery cells, and the second contactor in a second electrical path from a second terminal of the plurality of battery cells;
a first sensor and a second sensor configured to measure an electrical property across at least one of the first contactor or the second contactor,
the first sensor in a first signal path connected between the first electrical path and the second electrical path, and the second sensor in a second signal path connected between the first electrical path and the second electrical path, and
the first sensor and the second sensor sharing a reference point in the first electrical path or the second electrical path; and
a relay, in the first signal path or the second signal path, configured to be open when at least one of the first contactor or the second contactor is open.

2. The battery pack of claim 1, wherein the second signal path is connected at a downstream side of the first electrical path or of the second electrical path, and wherein the relay is in the second signal path.

3. The battery pack of claim 1, wherein the second signal path is connected at an upstream side of the first electrical path or of the second electrical path, and wherein the relay is in the second signal path.

4. The battery pack of claim 1, wherein the relay includes a coil connected in series with a negative contactor driver coil of a contactor driver configured to drive the first contactor or the second contactor.

5. The battery pack of claim 1, wherein the first contactor is a negative or positive contactor, and
wherein the relay and the first contactor are on a same driver.

6. The battery pack of claim 1, wherein the relay is driven by a high voltage interlock (HVIL) circuit or by a controller lacking a control connection to the first contactor and the second contactor.

7. The battery pack of claim 6, wherein the HVIL circuit includes a separate battery from the plurality of battery cells to power the HVIL circuit.

8. The battery pack of claim 1, wherein in a closed position of the relay, the first signal path or the second signal path is to be closed.

9. The battery pack of claim 1, wherein in an open position of the relay, the first contactor or the second contactor is to be open, and the relay in the open position is configured to block current flow across the first contactor or the second contactor.

10. The battery pack of claim 1, wherein an open position of the relay is to block charging of a Y-capacitance of a machine or application to which the battery pack is connected.

11. A battery system, comprising:
a battery cell;
a contactor configured to selectively isolate the battery cell from a load;
a first sensor and a second sensor configured to measure an electrical property across the contactor,
the first sensor connected in a first signal path connected at an upstream side of the contactor, and the second sensor connected in a second signal path connected at a downstream side of the contactor, and
the first sensor and the second sensor sharing a reference point that provides a pathway across the contactor; and
a relay, in the first signal path or the second signal path, configured to be open when the contactor is open.

12. The battery system of claim 11, wherein the contactor is a first contactor, and wherein the battery system further comprises a second contactor configured to selectively isolate the battery cell from the load.

13. The battery system of claim 12, wherein the first contactor is in a first electrical path from a first terminal of the battery cell, and the second contactor is in a second electrical path from a second terminal of the battery cell.

14. The battery system of claim 13, wherein the first signal path and the second signal path are connected between the first electrical path and the second electrical path.

15. The battery system of claim 13, wherein the first electrical path or the second electrical path includes a reference point to which the first sensor and the second sensor are electrically connected.

16. The battery system of claim 11, wherein in a closed position of the relay, the first signal path or the second signal path is to be closed.

17. The battery system of claim 11, wherein in an open position of the relay, the contactor is to be open, and the relay in the open position is configured to block current flow across the contactor.

18. A method, comprising:
causing, by a controller, opening of a relay concurrently with opening a contactor configured to selectively isolate a battery cell from a load,
wherein the relay is in a first signal path that includes a first sensor and is connected at an upstream side of the contactor, or in a second signal path that includes a second sensor and is connected at a downstream side of the contactor,
wherein the first sensor and the second sensor share a reference point that provides a pathway across the contactor, and
wherein opening the relay blocks current flow through the first signal path or the second signal path; and
causing, by the controller, closing of the relay concurrently with closing the contactor.

19. The method of claim 18, wherein the contactor is a first contactor, and wherein the method further comprises:
causing, by the controller, closing of a second contactor configured to selectively isolate the battery cell from the load, concurrently with closing the first contactor.

20. The method of claim 18, further comprising:
controlling, by the controller, the contactor to block charging of a Y-capacitance of a machine or application to which the battery cell is connected, while the relay is open.
